(19) United States
(12) Patent Application Publication
(10) Pub. No.: US 2020/0254560 A1
(43) Pub. Date: Aug. 13, 2020

(54) LASER PROCESSING APPARATUS, CONTROL METHOD OF LASER PROCESSING APPARATUS, AND CONTROL PROGRAM OF LASER PROCESSING APPARATUS

(71) Applicant: KANTATSU CO., LTD., Yaita-shi (JP)

(72) Inventor: Eiji OSHIMA, Yaita-shi (JP)

(21) Appl. No.: 16/665,470

(22) Filed: Oct. 28, 2019

(30) Foreign Application Priority Data
Oct. 26, 2018 (JP) 2018-201379

(51) Int. Cl. B23K 26/042; B23K 26/03; B23K 26/082; B23K 26/08; G05B 19/402

(52) U.S. Cl. CPC B23K 26/042; B23K 26/032; G05B 2219/33198; B23K 26/083; G05B 19/402; B23K 26/082

(57) ABSTRACT

A laser beam is readily positioned with a simple arrangement. A laser processing apparatus includes a processing stage on which a processing target object is processed, a light irradiator that performs irradiation by selecting one of a visible laser beam and a processing laser beam, and an adjuster that adjusts a position of the processing stage based on an irradiation position of the visible laser beam with which one of the processing stage and the processing target object is irradiated. The light irradiator irradiates, with the processing laser beam, the processing target object arranged on the processing stage adjusted by the adjuster.

### BACKGROUND OF THE INVENTION

### Field of the Invention

The present invention relates to a laser processing apparatus, a control method of the laser processing apparatus, and a control program of the laser processing apparatus.

### Description of the Related Art

In the above technical field, patent literature 1 discloses a technique of performing positioning by relatively adjusting, by an adjustment mechanism, the angle of the optical axis of the incident surface of the second optical fiber with respect to the optical axis of a laser beam recondensed by a recondensing optical system.

[Patent Literature 1] Japanese Patent Laid-Open No. 2017-173371

### SUMMARY OF THE INVENTION

In the technique described in the above literature, however, it is impossible to readily position a laser beam with a simple arrangement.

The present invention provides a technique of solving the above-described problem.

One example aspect of the present invention provides a laser processing apparatus comprising:

a processing stage on which a processing target object is processed;

a light irradiator that performs irradiation by selecting one of a visible laser beam and a processing laser beam; and

an adjuster that adjusts a position of the processing stage based on an irradiation position of the visible laser beam with which one of the processing stage and the processing target object is irradiated, wherein the light irradiator irradiates, with the processing laser beam, the processing target object arranged on the processing stage adjusted by the adjuster.

Another example aspect of the present invention provides a control method of a laser processing apparatus including a processing stage on which a processing target object is processed, comprising:

performing irradiation by selecting one of a visible laser beam and a processing laser beam; and

adjusting a position of the processing stage based on an irradiation position of the visible laser beam with which one of the processing stage and the processing target object is irradiated, wherein in the performing the irradiation, the processing target object arranged on the processing stage adjusted in the adjusting is irradiated with the processing laser beam.

Still other example aspect of the present invention provides a control program of a laser processing apparatus including a processing stage on which a processing target object is processed, the program for causing a computer to execute a method, comprising:

performing irradiation by selecting one of a visible laser beam and a processing laser beam; and

adjusting a position of the processing stage based on an irradiation position of the visible laser beam with which one of the processing stage and the processing target object is irradiated, wherein in the performing the irradiation, the processing target object arranged on the processing stage adjusted in the adjusting is irradiated with the processing laser beam.

According to the present invention, it is possible to readily position a laser beam with a simple arrangement.

### BRIEF DESCRIPTION OF THE DRAWINGS

FIG. 1 is a view showing the arrangement of a laser processing apparatus according to the first example embodiment of the present invention;

FIG. 2 is a view showing the arrangement of a laser processing apparatus according to the second example embodiment of the present invention;

FIG. 3 is a view for explaining an example of the arrangement of a light irradiator of the laser processing apparatus according to the second example embodiment of the present invention;

FIG. 4 is a table showing an example of an adjustment table provided in the laser processing apparatus according to the second example embodiment of the present invention;

FIG. 5 is a block diagram for explaining the hardware arrangement of the laser processing apparatus according to the second example embodiment of the present invention; and

FIG. 6 is a flowchart for explaining the operation procedure of the laser processing apparatus according to the second example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

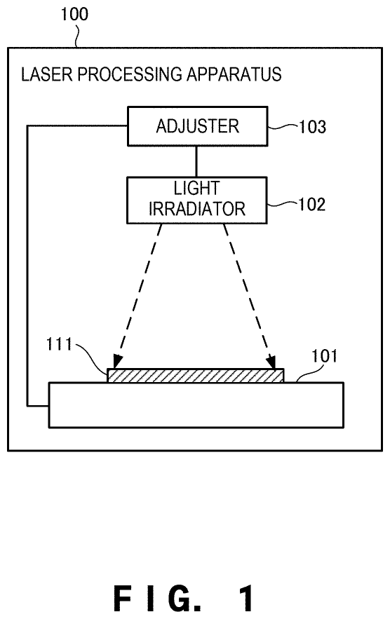

A laser processing apparatus 100 according to the first example embodiment of the present invention will be described with reference to FIG. 1. The laser processing apparatus 100 is an apparatus that processes a processing target object or the like using a laser beam.

As shown in FIG. 1, the laser processing apparatus 100 includes a processing stage 101, a light irradiator 102, and an adjuster 103. The processing stage 101 is a place where a processing target object 111 is processed. The light irradiator 102 performs irradiation by selecting one of a visible laser beam and a processing laser beam. The adjuster 103 adjusts the position of the processing stage 101 based on the irradiation position of the visible laser beam with which the processing stage 101 or the processing target object 111 is irradiated. The light irradiator 102 irradiates, with the processing laser beam, the processing target object 111 arranged on the processing stage 101 adjusted by the adjuster 103.

According to this example embodiment, it is possible to readily position the laser beam with the simple arrangement.

### Second Example Embodiment

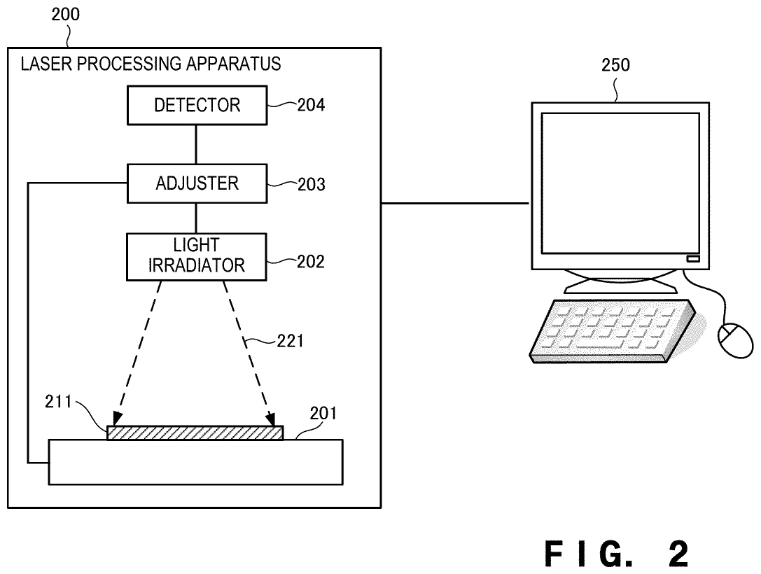

A laser processing apparatus according to the second example embodiment of the present invention will be described next with reference to FIGS. 2 to 6. FIG. 2 is a view for explaining the arrangement of the laser processing apparatus according to this example embodiment. A laser processing apparatus 200 includes a processing stage 201, a light irradiator 202, an adjuster 203, and a detector 204. The processing stage 201 is a place where a processing target object 211 is processed. That is, the processing target object 211 is processed on the processing stage 201.

The light irradiator 202 irradiates the processing stage 201 or the processing target object 211 with a visible laser beam or a processing laser beam. The light irradiator 202 performs irradiation by switching the laser beam for irradiation in accordance with the application purpose or aim. For example, when processing the processing target object 211, the light irradiator 202 irradiates the processing target object 211 with the processing laser beam for processing. When positioning the irradiation position of the processing laser beam, the processing stage 201 or the processing target object 211 is irradiated with the visible laser beam.

The adjuster 203 adjusts the position of the processing stage 201 based on the irradiation position of the visible laser beam with which the processing stage 201 or the processing target object 211 is irradiated. That is, the position of the processing stage 201 is adjusted by being moved in the X and Y directions so that a desired position is irradiated with the emitted visible laser beam. Note that the position of the processing stage 201 may be adjusted manually or automatically.

The detector 204 detects the irradiation position of the visible laser beam. The detector 204 is, for example, a sensor such as a CCD (Charged Coupled Devices) sensor or a CMOS (Complementary Metal-Oxide-Semiconductor) sensor but is not limited to them.

Then, the adjuster 203 receives a detection result detected by the detector 204, that is, data of the irradiation position of the visible laser beam, and adjusts the position of the processing stage 201 by moving it in the X and Y directions based on the received irradiation position data.

The operator of the laser processing apparatus 200 operates the laser processing apparatus 200 using an operation computer 250. The operator transmits processing data (shaping data) created by the CAD (Computer Aided Design) of the operation computer 250 to the laser processing apparatus 200 to be used for processing or shaping. Note that the CAD may be installed in a computer different from the operation computer 250.

Upon receiving the processing data from the operation computer 250, the laser processing apparatus 200 controls irradiation with a laser beam 221 based on the received processing data. Note that creation of the processing data or shaping data is not limited to creation using the CAD, and may be, for example, creation using CAE (Computer Aided Engineering), an application of a smartphone, or the like.

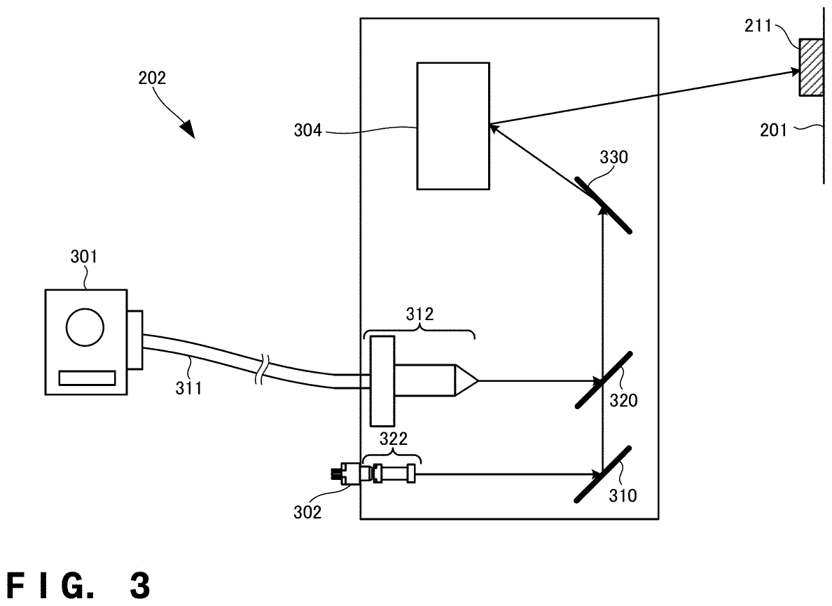

FIG. 3 is a view for explaining the arrangement of the light irradiator of the laser processing apparatus according to this example embodiment. The light irradiator 202 includes a light source 301, a laser source 302, and a two-dimensional MEMS (Micro Electro Mechanical System) mirror 304. The two-dimensional MEMS mirror 304 is an electromechanical mirror.

The light source 301 serves as an oscillator of a solid-state laser, a gas laser, or a high-power semiconductor laser. A laser beam emitted from the light source 301 is guided to a condenser 312 through an optical fiber 311 (guidance unit) that guides a laser beam. The condenser 312 includes a condenser lens and a collimator lens. For example, a laser beam entering the condenser 312 is condensed by the condenser lens, is collimated by the collimator lens, and is then emitted.

The laser source 302 is a visible laser source. That is, a laser beam emitted from the laser source 302 is a visible laser beam. The visible laser beam emitted from the laser source 302 is guided to a condenser 322. The condenser 322 includes a condenser lens and a collimator lens. The laser source 302 is a semiconductor LD (Laser Diode), and is a laser beam oscillation element that emits (oscillates) a visible laser beam or the like. For example, the visible laser beam entering the condenser 322 is condensed by the condenser lens, is collimated by the collimator lens, and is then emitted.

The two-dimensional MEMS mirror 304 is an electromechanical mirror. The two-dimensional MEMS mirror 304 is a driving mirror that is driven based on a control signal input from the outside, and vibrates to reflect the laser beam while changing the angle in the horizontal direction (X direction) and the vertical direction (Y direction). The laser beam reflected by the two-dimensional MEMS mirror 304 is corrected by a view angle correction element (not shown) in terms of a view angle. Then, the laser beam which has been corrected in terms of the view angle is scanned on the processing target object 211 or a process surface, thereby performing desired processing or shaping. Note that the view angle correction element is installed, as needed. Note that two one-dimensional MEMS mirrors may be used, instead of using the two-dimensional MEMS mirror 304.

The laser beam emitted from the light source 301 is reflected by mirrors 320 and 330 to reach the two-dimensional MEMS mirror 304. Similarly, the laser beam emitted from the laser source 302 is reflected by a mirror 310 and the mirror 330 to reach the two-dimensional MEMS mirror 304. The mirror 330 is arranged in a bottom portion (bottom surface) of the light irradiator 202. The mirror 310 reflects the reflected light of the laser beam from the laser source 302 downward to the mirror 330 arranged on the bottom surface. The mirror 320 reflects the reflected light of the laser beam from the light source 301 downward to the mirror 330 arranged on the bottom surface. The mirror 330 reflects each of the laser beams from the mirrors 310 and 320 upward to the two-dimensional MEMS mirror 304 arranged above the mirror 330. The two-dimensional MEMS mirror 304 scans the reflected light from the mirror 330 in the two-dimensional directions to perform irradiation.

Each of the laser beams emitted from the light source 301 and the laser source 302 is reflected by the mirror 310 or 320, and passes through the two-dimensional MEMS mirror 304, thereby reaching the processing stage 201 or the processing target object 211.

That is, the processing laser beam emitted from the light source 301 and the laser beam emitted from the laser source 302 pass through the same optical path to reach the processing stage 201 or the processing target object 211. Therefore, if positioning is performed using the visible laser beam, a position which is irradiated with the visible laser beam is irradiated with the processing laser beam, and thus the processing laser beam can readily be positioned. It is, therefore, possible to readily decide the start position of processing by the processing laser beam.

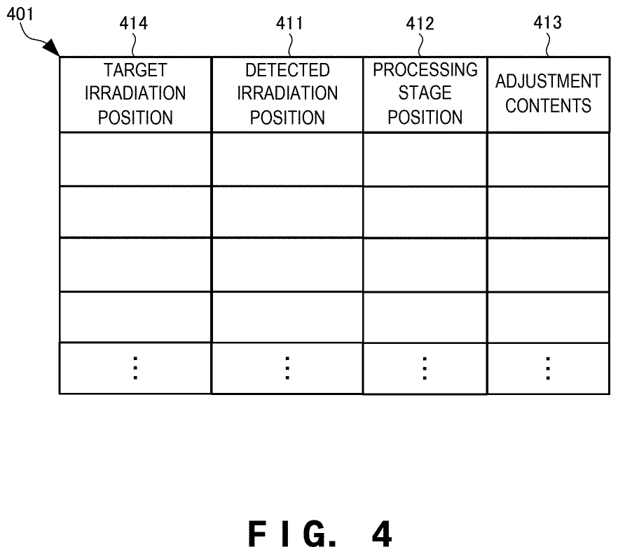

FIG. 4 is a table showing an example of an adjustment table provided in the laser processing apparatus according to this example embodiment. An adjustment table 401 stores a detected irradiation position 411, a processing stage position 412, and adjustment contents 413 in association with a target irradiation position 414. The target irradiation position 414 indicates a target position to be irradiated. The detected irradiation position 411 indicates a position irradiated with the visible laser beam emitted from the light irradiator 202. The processing stage position 412 indicates the position of the processing stage 201 when the light irradiator 202 performs irradiation with the visible laser beam for position adjustment. The adjustment contents 413 indicate contents of position adjustment of the processing stage 201 necessary for positioning of the processing laser beam based on the relationship between the detected irradiation position of the visible laser beam and the position of the processing stage 201. The laser processing apparatus 200 performs positioning of irradiation with the processing laser beam with reference to, for example, the adjustment table 401.

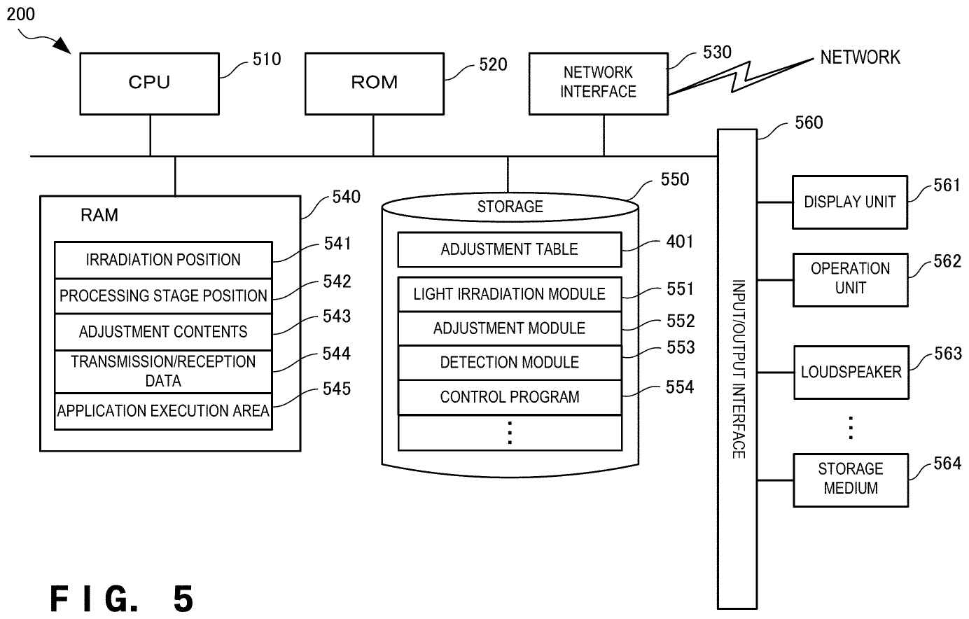

FIG. 5 is a block diagram showing the hardware arrangement of the laser processing apparatus according to this example embodiment. A CPU (Central Processing Unit) 510 is an arithmetic control processor, and implements the functional components of the laser processing apparatus 200 shown in FIG. 2 by executing a program. The CPU 510 may include a plurality of processors to parallelly execute different programs, modules, tasks, or threads. A ROM (Read Only Memory) 520 stores permanent data such as initial data and a program, and other programs. A network interface 530 communicates with another apparatus via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads out transmission/reception data in or from the area of a RAM (Random Access Memory) 540. It is desirable to provide a DMAC (Direct Memory Access Controller) (not shown) for transferring data between the RAM 540 and a storage 550. Furthermore, the CPU 510 processes the data by recognizing that the data has been received by or transferred to the RAM 540. The CPU 510 prepares a processing result in the RAM 540, and delegates succeeding transmission or transfer to the network interface 530 or DMAC.

The RAM 540 is a random access memory used as a temporary storage work area by the CPU 510. An area to store data necessary for implementation of this example embodiment is allocated to the RAM 540. An irradiation position 541 is data indicating the irradiation position of the visible laser beam emitted from the light irradiator 202. A processing stage position 542 is data indicating the position of the processing stage 201 at the time of irradiation with the visible laser beam. Adjustment contents 543 are data indicating contents of adjustment of the position of the processing stage 201 performed based on the relationship between the irradiation position of the visible laser beam and the position of the processing stage 201. These data are deployed from, for example, the adjustment table 401.

Transmission/reception data 544 is data transmitted/received via the network interface 530. The RAM 540 includes an application execution area 545 for executing various application modules.

The storage 550 stores a database, various parameters, or the following data or programs necessary for implementation of this example embodiment. The storage 550 stores the adjustment table 401. The adjustment table 401 is the table, shown in FIG. 4, for managing the relationship between the detected irradiation position 411 and the adjustment contents 413 and the like.

The storage 550 also stores a light irradiation module 551, an adjustment module 552, and a detection module 553. The light irradiation module 551 is a module that irradiates the processing stage 201 or the processing target object 211 with the visible laser beam or the processing laser beam. The adjustment module 552 is a module that adjusts the position of the processing stage 201 based on the position irradiated with the visible laser beam. The detection module 553 is a module that detects the position irradiated with the visible laser beam. These modules 551 to 553 are read out by the CPU 510 into the application execution area 545 of the RAM 540, and executed. A control program 554 is a program for controlling the whole laser processing apparatus 200.

An input/output interface 560 interfaces input/output data with an input/output device. The input/output interface 560 is connected to a display unit 561 and an operation unit 562. In addition, a storage medium 564 may be connected to the input/output interface 560. A loudspeaker 563 serving as a voice output unit, a microphone (not shown) serving as a voice input unit, or a GPS position determiner may also be connected. Note that programs and data which are associated with the general-purpose functions of the laser processing apparatus 200 and other feasible functions are not shown in the RAM 540 or the storage 550 of FIG. 5.

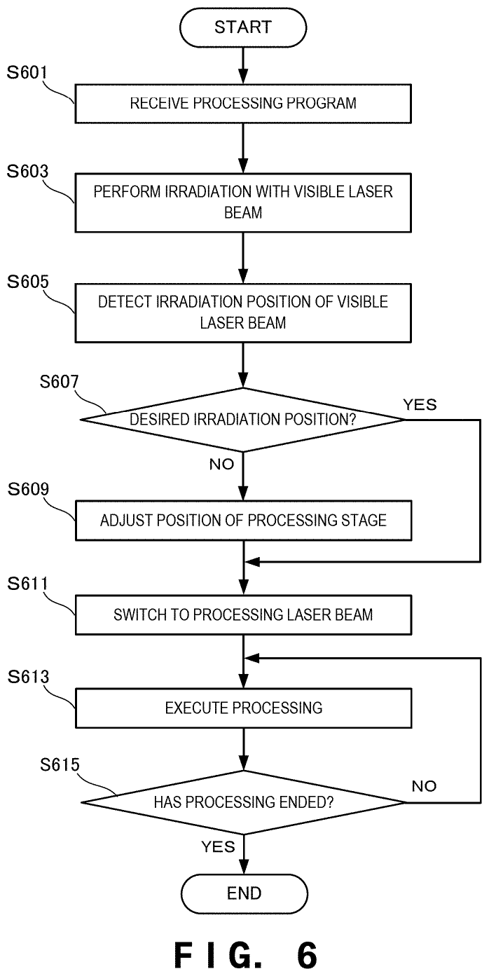

FIG. 6 is a flowchart for explaining the processing procedure of the laser processing apparatus according to this example embodiment. This flowchart is executed by the CPU 510 of FIG. 5 using the RAM 540, thereby implementing the functional components of the laser processing apparatus 200 shown in FIG. 2.

In step S601, the laser processing apparatus 200 receives a processing program. In step S603, the laser processing apparatus 200 performs irradiation with the visible laser beam. In step S605, the laser processing apparatus 200 detects the irradiation position of the visible laser beam. In step S607, the laser processing apparatus 200 determines whether a desired position is irradiated with the visible laser beam.

If the desired position is irradiated with the visible laser beam (YES in step S607), the laser processing apparatus 200 advances to step S611; otherwise (NO in step S607), the laser processing apparatus 200 advances to step S609. In step S609, the laser processing apparatus 200 adjusts the position of the processing stage by moving it so that the desired position is irradiated with the visible laser beam. In step S611, the laser processing apparatus 200 switches the laser beam for irradiation from the visible laser beam to the processing laser beam. In step S613, the laser processing apparatus 200 executes processing. In step S615, the laser processing apparatus 200 determines whether the processing has ended. If the processing has not ended (NO in step S615), the laser processing apparatus 200 returns to step S613; otherwise (YES in step S615), the laser processing apparatus 200 ends the processing process.

According to this example embodiment, since the visible laser beam for positioning and the processing laser beam for processing pass through the same optical path to reach the processing target object or the processing stage, the processing start position can be simply and easily decided. Furthermore, since the visible laser beam is used, the processing laser beam can readily be positioned without destroying the processing target object or the apparatus.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. A laser processing apparatus comprising:
a processing stage on which a processing target object is processed;
a light irradiator that performs irradiation by selecting one of a visible laser beam and a processing laser beam; and
an adjuster that adjusts a position of said processing stage based on an irradiation position of the visible laser beam with which one of said processing stage and the processing target object is irradiated,
wherein said light irradiator irradiates, with the processing laser beam, the processing target object arranged on said processing stage adjusted by said adjuster.

2. The apparatus according to claim 1, further comprising a detector that detects the irradiation position of the visible laser beam,
wherein said adjuster adjusts the position of said processing stage based on a detection result of the irradiation position of the visible laser beam obtained by said detector.

3. The apparatus according to claim 1 or 2, further comprising a guidance unit that guides the processing laser beam from a processing laser source to said light irradiator.

4. The apparatus according to claim 1, wherein said light irradiator includes an electromechanical mirror.

5. A control method of a laser processing apparatus including a processing stage on which a processing target object is processed, comprising:
performing irradiation by selecting one of a visible laser beam and a processing laser beam; and
adjusting a position of the processing stage based on an irradiation position of the visible laser beam with which one of the processing stage and the processing target object is irradiated,
wherein in the performing the irradiation, the processing target object arranged on the processing stage adjusted in the adjusting is irradiated with the processing laser beam.

6. A control program of a laser processing apparatus including a processing stage on which a processing target object is processed, the program for causing a computer to execute a method, comprising:
performing irradiation by selecting one of a visible laser beam and a processing laser beam; and
adjusting a position of the processing stage based on an irradiation position of the visible laser beam with which one of the processing stage and the processing target object is irradiated,
wherein in the performing the irradiation, the processing target object arranged on the processing stage adjusted in the adjusting is irradiated with the processing laser beam.
